(19) United States
(12) Patent Application Publication
(10) Pub. No.: US 2023/0040636 A1
(43) Pub. Date: Feb. 9, 2023

(54) Biodegradable Multi-Layer Packaging Element, Such as a Foil or Wrap, for a Food Product, Packaging Unit with Such Packaging Element, and Method for Manufacturing Such Packaging Element

(71) Applicant: Huhtamaki Molded Fiber Technology B.V., Leeuwarden (NL)

(72) Inventors: Harald John Kuiper, Leeuwarden (NL); Jan Hendrik Timmerman, Leeuwarden (NL)

(21) Appl. No.: 17/792,838

(22) PCT Filed: Jan. 14, 2021
(86) PCT No.: PCT/NL2021/050017

§ 371 Date: Jul. 14, 2022

(30) Foreign Application Priority Data
Jan. 17, 2020 (NL) 2024698
Mar. 30, 2020 (NL) 2025240

(51) Int. Cl. B65D 65/40; B65D 65/46; B32B 27/36; B32B 7/12; B32B 27/30; B32B 27/08; B32B 27/10; B32B 3/26; B32B 27/20; B65D 81/34

(52) U.S. Cl. CPC B65D 65/40; B65D 65/466; B32B 27/36; B32B 7/12; B32B 27/306; B32B 27/08; B32B 27/10; B32B 3/266; B32B 27/20; B65D 81/3453; B32B 2553/00; B32B 2439/70; B32B 2307/7163; B32B 2307/732; B32B 2307/4026; B32B 2435/02; B32B 2307/31; B32B 2250/40; B32B 2307/412; B32B 2307/7244; B32B 2307/7246; B32B 2307/75; B32B 2439/62

(57) ABSTRACT

The present invention relates to a biodegradable multi-layer packaging element, such as a foil or wrap, for a food product, a food packaging unit comprising such multi-layer and a method for manufacturing such biodegradable multi-layer, with the multi-layer comprising: —an inner cover layer comprising an amount of a biodegradable aliphatic polyester; —a first intermediate layer of a biodegradable material for connecting and/or sealing adjacent layers; —a functional layer comprising a vinyl alcohol polymer; —a second intermediate layer of a biodegradable material for connecting and/or sealing adjacent layers; and —an outer cover layer comprising an amount of a biodegradable aliphatic polyester.

The present invention relates to a biodegradable multi-layer packaging element such as foils or wraps for food products. Such foils or wraps are used as packaging element for food trays or containers. Also, such foils or wraps are used as packaging element for covers for food products, ice cream wraps, chocolate bar wraps etc.

Packaging elements are commonly used. Packaging elements that come into contact with food products are subject to many restrictions. This often requires providing an additional film layer, with the film layer acting as a barrier. This barrier separates the food product from its environment.

One of the problems with conventional packaging elements for food products is that the packaging elements are often not sustainable, or at least not fully sustainable. Furthermore, this use of an additional film layer also puts restrictions on the recycling possibilities.

The present invention has for its object to obviate or at least reduce the above stated problems in conventional food packaging units and to provide a packaging element that is more sustainable and/or has improved recycling possibilities.

For this purpose, the present invention provides a biodegradable multi-layer packaging element, with the multi-layer comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

In the context of this invention degradable relates to degradation resulting in loss of properties, while biodegradable relates to degradation resulting from the action of microorganisms such as bacteria, fungi and algae. Compostable relates to degradation by biological process to yield carbon dioxide (CO), water, inorganic compounds and biomass.

The biodegradable multi-layer packaging element according to the invention is used as foil or wrap for food products, for example. Such foils or wraps are used as packaging element for food trays or containers. Also, such foils or wraps are used as packaging element for covers for food products, ice cream wraps, chocolate bar wraps etc.

The packaging element according to the invention is preferably compostable thereby providing a sustainable packaging element. This provides a biodegradable alternative material to conventionally used plastics, for example. In several of the presently preferred embodiments of the invention the packaging element is also marine degradable, thereby further improving the sustainability of the packaging element.

According to the present invention the biodegradable multi-layer, preferably a laminated multi-layer, comprises at least five material layers. It will be understood that additional layers can also be provided in accordance to the present invention.

The inner and outer cover layer comprise an amount of a biodegradable aliphatic polyester, such as poly(butylene succinate) also referred to as PBS, polybutylene sebacate terephthalate also referred to as PBST, polyhdroxyalkanoate also referred to as PHA, for example including polyhdroxybutyraat also referred to as PHB and/or poly(3-hydroxybutyrate-co-3-hydroxyhexanoate) also referred to as PHBH and/or poly(3-hydroxybutyrate-co-3-hydrovalerate) also referred to as PHBV, polycaprolactone also referred to as PCL, poly(lactic acid) also referred to as PLA, poly(glycolic acid) also referred to as PGA, polybutyleneadipate-terphthalate also referred to as PBAT and also known with its commercial name ecoflex, and/or other suitable components, such as poly(alkylene dicarboxylate) other than PBS, PBAT and PBST, poly(lactic-co-glycolic acid) also referred to as PLGA, including mixtures or blends. An example of such a blend is a blend of PBAT and PLA, also known with its commercial name Ecovio, or a blend of PBAT and PBS, or another suitable blend that is preferably home compostable. In some of the presently preferred embodiments of the invention the biodegradable aliphatic polyester is bio-based. This further improves the sustainability of the packaging unit of the invention.

The inner and outer cover layer may also comprise a biodegradable composition of materials, such as a combination of starch and one of the aforementioned biodegradable aliphatic polyesters, such as PBS and/or PLA and/or PBAT and/or PBST. This improves the surface properties of the biodegradable (laminated) multi-layer, and also of any packaging unit provided therewith. This includes the so-called wipeability of the packaging element. Wipeability relates to the possibility to remove stains from the surface and reducing or even preventing penetration into the material. Also, it may provide more possibilities for masking (hiding) undesirable stains and/or promoting the compostable effect of the packaging element. The surface properties also relate to grease resistance such that the (chemical properties) of the packaging element can be remained during its use, for example. Also, the penetration of oil originating from the food product, such as pasta or French fries, into the packaging element can be reduced. Also, water barrier properties can be improved to reduce the penetration of water into the packaging unit and thereby reducing ridging problems, for example.

In addition, the (laminated) multi-layer comprises a functional central layer comprises a biodegradable and compostable vinyl alcohol polymer. This function layer contributes to the multi-layer properties, such as acting as a gas barrier. For example, the functional layer may provide an effective oxygen (O₂) barrier. This improves shelf-file of the food product(s) in the packaging unit.

In a presently preferred embodiment the vinyl alcohol polymer comprises a highly amorphous vinyl alcohol polymer (HAVOH), including copolymers such as butandiol vinyl alcohol co-polymer (BVOH). Such polymer or polymer mixture also provides an effective barrier, especially a gas barrier, and more specifically an oxygen (O₂) barrier. Such barrier can effectively be used to further improve the shelf-life of the food product(s). In addition, this also reduces food waste, thereby further improving the sustainable effects of the (food) packaging element according to the present invention. Experiments showed a surprisingly effective oxygen (O₂) barrier, especially at relative humidities up to 60% as compared to conventional materials. An example of BVOH is G-Polymer.

As a further advantage, vinyl alcohol polymers are mouldable and extrudable. This renders it possible to co-extrude the (laminated) multi-layer with the basic material of a packaging unit, especially the basic material of the compartment(s) thereof, such as the moulded fiber or fluff pulp material. The co-extruded material can be moulded or deep-drawn. This provides efficient and effective manufacturing processes for the packaging element of the present invention and/or packaging unit provided with such packaging element. The efficiency can even be improved further by recycling the remainders after punching the material into the manufacturing process.

The inner and outer cover layers are separated from the central functional layer by an intermediate layer, to which can also be referred to as a tie layer. Such intermediate layer is substantially of a biodegradable material and connects and/or seals its adjacent layers. Preferably, the intermediate layers improve or at least contribute to maintaining the desired properties of the central functional layer, such as acting as a gas barrier. For example, the intermediate layers seal the central functional layer against liquid penetration to maintain the gas barrier properties of the functional layer. The (compostable) multi-layer can be manufactured using different techniques, for example using blown film and melt cast extrusion techniques, co-injection optionally with integrated outer and intermediate layers, and (paper) coating.

It will be understood that additional separate layers can be provided in the (laminated) multi-layer, providing 7, 9 or 11 layers of material improving the overall properties of the (laminated) multi-layer, for example including grease barrier and odor barrier. In a further preferred embodiment of the invention, the biodegradable multi-layer comprises at least two functional layers. Providing two or more functional layers improves the performance of the barrier layers and/or increases the flexibility to provide multiple barriers for optionally different properties. For example, a multiple barrier for oxygen can be applied or different barriers can be applied for oxygen and moisture. This improves the performance and/or flexibility.

Preferably, the at least two biodegradable (functional) multi-layers are separated by a layer of a biodegradable aliphatic polyester. Optionally, additional intermediate layers are provided. In a further alternative embodiment of the invention with two functional layers the total thickness is in the range of 100 to 150 μm, and is preferably about 125 μm. The outer cover layers preferably comprise a blend of PBAT and PLA or PBS or PBST, and have a thickness in the range of 30 to 35 μm. Two functional layers preferably comprise a polyvinyl alcohol, and have a thickness in the range of 3.5 to 4 μm and an additional flexibility layer has a thickness in the range of 30 to 40 μm. All these layers are preferably separated with an intermediate layer, preferably form a biodegradable material, such as PBS, having a thickness in the range of 3 to 5 μm. This embodiment therefore has nine layers. In this embodiment the flexible layer is a blend of biopolymers, for example with PBS, PBAT and/or PBST. It will be understood that another number of layers can also be envisaged in accordance to the invention.

It was shown that by applying a biodegradable (laminated) multi-layer the overall properties of the packaging element were improved. In fact, a packaging unit provided with a biodegradable (laminated) multi-layer enables to provide a compartment to hold different kinds of food, including ready-to-eat meals with pasta sauce, for example.

The packaging element according to the invention shows a significant reduction in the water vapor transmission rate (WVTR) as compared to conventional foils or wraps. For example, conventional packaging elements show a WVTR of up to 200 g/m² d. Experiments with a multi-layer according to the present invention shows a WVTR below 5 g/m² d, and below 4 g/m² d, and 3 g/m² d. It will be understood that this is a significant improvement in WVTR. This also reduces loss of aroma significantly. This improves food quality and shelf-life. For example, due to the low(er) WVTR the packing of dry food products, like coffee, snacks, noodles, nuts and candy, is improved, such that shelf-life is extended. In addition, this enables the omission of additional packaging layers of the food and/or packaging unit. This enables a full biodegradable packaging element with minimal material cost. This also reduces the need for a secondary packaging to maintain product quality. Also the oxygen barrier is improved with the packaging unit of the invention. Experiments showed that the oxygen transfer rate (OTR, at 23° C. and 0% RH) can even be reduced to below 2 ml/m² d. In a presently preferred embodiment of the invention the OTR is below 1 ml/m² d and more preferably even below 0.1 ml/m² d. This improves freshness of the food products and the shelf-life.

The combination of the barrier properties and the wipeability of the biodegradable (laminated) multi-layer in a packaging unit according to the invention enables the use of these packaging units for a wide range of food products, including meat trays or meat packaging, for example. In fact, the packaging unit of the invention substantially prevents stains in the product caused by hemoglobin contained in the meat. This improves the visual appearance of the product and the shelf-life of the product.

In a presently preferred embodiment the (laminated) multi-layer is a co-extruded (laminated) multi-layer. Co-extrusion enables constructing a layer comprising multiple sub-layers by melting, extruding, focusing and joining the separate layers.

In a further preferred embodiment of the invention the biodegradable multi-layer packaging element further comprises a paper layer.

Providing a paper layer provides additional strength and stability to the packaging element. Furthermore, the paper layer enables display of information about the food product and/or manufacturer, for example. Optionally, a second paper layer is provided, preferably on the other side of the (laminated) multi-layer to further enhance the properties of the packaging element.

The paper layer is preferably from a so-called greaseproof paper, more preferably a greaseproof paper that classifies as a baking paper. This paper layer preferably comprises short length fibers, being free of halogenated compounds, such as so-called fluorochemicals, and is highly resistant to the permeability of oils and greases. The grease resistance is measured by the KIT value, through the KIT test, and for this kind of paper (layer) it is preferably of the value 12, which means the maximum possible grease/oil resistance that can be achieved. The paper layer may have different colors. Preferably, the paper layer is bond to the biofilm layers, through heat and pressure, for example at a temperature of 120° C. In addition, or as an alternative, the paper layer comprises an amount of micro-fibrillated cellulose fibers with an intense inter-fiber hydrogen (H₂) bonding.

In some of the presently preferred embodiments the paper layer is provided with an opening or cut that acts as window for the packaging element. Such window enables a consumer to see and inspect the contents of the packaging element. A further advantage of such combination of a paper layer for display of information and a window for providing a view on the contents of the packaging element is that it obviates the need for a separate (carton) sleeve around a ready-to-eat meal, for example. This significantly contributes to the reduction of waste.

In one of the presently preferred embodiments of the invention the thickness of the individual layers is within the range of 1.5 to 50 μm, preferably in the range of 1.5 to 30 μm, and wherein the total thickness of the biodegradable (laminated) multi-layer is in the range of 20 to 150 μm. These layers provide a biodegradable (laminated) multi-layer having an acceptable thickness and providing effective barrier properties, for example. Optionally, one or more additional paper layers are provided in combination with the (laminated) multi-layer.

In one of the presently preferred embodiments of the invention the functional layer has a thickness in the range of 1.5 to 10 μm and is most preferably in the range of 3 to 5 μm and more preferably in the range of 2 to 5 μm. The intermediate layers have a thickness that is preferably also in the range of 1.5 to 10 μm and most preferably in the range 1.5 to 5 μm or 1.5 to 3 μm or 3 to 7 μm for an individual layer. The inner and outer cover layer have a thickness that is preferably in the range of 20 to 50 μm, more preferably in the range of 20 to 40 μm. It will be understood that different combinations of layers and thicknesses can be made. It is presently preferred to have a total thickness of the biodegradable multi-layer in the range of 23 to 70 μm, more preferably in the range of 30 to 60 μm, even more preferably in the range of 30 to 50 μm, and most preferably a thickness of about 40 μm.

In a further presently preferred embodiments the functional layer has a thickness in the range of 1.5 to 10 μm and is most preferably in the range of 3 to 7 μm. The intermediate layers have a thickness that is preferably also in the range of 1.5 to 10 μm, more preferably in the range 1.5 to 3 μm, and most preferably in the range of 1.8 to 3 μm for an individual layer. Optionally, the multi-layer has a functional layer that is positioned asymmetrically. This positioning is achieved by having a different thickness of one or more of the corresponding layers on both sides of the functional layer, preferably the outer or cover layer on the food side of the multi-layer has a reduced thickness. This asymmetric positioning of the functional barrier layer enables thickness reduction (and cost reduction) of the layer in contact with the food and enables use of the thick(er) layer in contact with the tray to provide a good bonding. The principle of bonding the film to the fiber surface, preferably without the use of glue or adhesive layers, is based on bringing the multilayer structure close to the melting point of the layer that needs to bond/attach to the fiber tray. Therefore, a thicker layer at the fiber tray side enables a better mechanical bonding due to the fiber layer of the tray. The layers in contact with the food can be as thin as possible and just thick enough to protect the functional (barrier) layer, for example if this layer is water soluble and moisture sensitive. This further improves the packaging element.

In such presently preferred embodiment the inner and outer cover layer have a thickness that is preferably in the range of 1.5 to 50 μm, more preferably in the range of 20 to 50 μm, and even more preferably in the range of 30 to 40 μm. As mentioned the inner (food side) and outer cover layer may have a different thickness. It will be understood that different combinations of layers and thicknesses can be made.

In such presently preferred embodiment it is presently preferred to have a total thickness of the biodegradable multi-layer in the range of 70 to 150 μm, more preferably in the range of 75 to 120 μm, more preferably in the range of 70 to 90 μm, and most preferably a thickness of about 80 μm. Experiments have shown an effective barrier, especially an oxygen barrier, having a lower weight that can be applied cost effectively. Optionally, one or more additional paper layers are provided in combination with the (laminated) multi-layer. In embodiments of packaging units with the biodegradable multi-layer acting as a foil, more specifically a top seal film, this top seal film is preferably provided with a similar multi-layer construction and a thickness in the range of 25 to 100 μm, more preferably in the range of 30 to 50 μm. The thickness of the intermediate and functional layers is preferably similar to the multi-layer, while the inner and outer cover layers are provided with a reduced thickness. Optionally, one or more additional paper layers are provided in combination with the (laminated) multi-layer. In a number of applications the reduced thickness of the top seal film as compared to the (laminated) multi-layer is possible because the top seal film does not need to be deep-drawn in the manufacturing process.

As a further advantage of the use of a biodegradable aliphatic polyester, the so-called heat seal ability of the packaging element is improved. This further improves food packaging characteristics.

An even further advantage of introducing an amount of a biodegradable aliphatic polyester in a packaging element is that the properties of the packaging element can be adjusted by mixing or blending the main biodegradable aliphatic polyester with other polymers or agents. Also, it is possible to prepare the biodegradable aliphatic polyester material for (paper) coating and printing. Furthermore, in some embodiments, digital printing may be applied to the packaging element to reduce the total cost of the packaging unit. This further improves the sustainability of the packaging element. Also, a paper look may be achieved.

As mentioned earlier, the food packaging element may comprise one or more further agents in addition to the use of biodegradable aliphatic polyester. This enables a specific design of the food packaging element characteristics and properties according to customer's specifications or needs taking into account the specific food product.

Preferably, the biodegradable aliphatic polyester comprises an amount of one or more of the aforementioned biopolymers. Preferably, the use of biodegradable aliphatic polyester is combined with the use of further additives or substances that aim at improving or achieving specific properties of the packaging element. In further presently preferred embodiments the bio-polymers that are applied originate from so-called non-gmo (non-genetically modified organisms) biopolymers. For example, it was shown that the use of PBS and/or PLA and/or PBAT and/or PBST in addition to another biodegradable aliphatic polyester may improve the strength and stability of the packaging element, thereby providing a stronger packaging element and/or requiring less raw material.

According to one of the preferred embodiments of the invention the biodegradable aliphatic polyester comprises an amount of PHBH. Experiments showed an improved temperature behaviour improving manufacturing possibilities by providing an acceptable behaviour up to 200° C. and even up to 220° C.

According to one of the alternative preferred embodiments of the invention the biodegradable aliphatic polyester comprises an amount of PBAT and/or PBST. PBAT and PBST are one of the biodegradable aliphatic polyesters. Experiments showed an improved temperature behaviour improving manufacturing possibilities by providing an acceptable behaviour up to 200° C. and even up to 220° C. Furthermore, the experiments showed an improved biodegradability of the biodegradable multi-layer packaging element.

According to one of the alternatively preferred embodiments of the invention the biodegradable aliphatic polyester comprises an amount of PBS. PBS is one of the biodegradable aliphatic polyesters. PBS can also be referred to as polytetramethylene succinate. PBS decomposes naturally into water, CO₂ and biomass. The use of PBS as a compostable material contributes to providing a sustainable product.

The use of PBS and/or PBAT and/or PBST is possible in food-contact applications including food packaging units from a moulded pulp material. An advantage of the use of PBS and/or PBAT and/or PBST is that the decomposition rate of PBS and/or PBAT and/or PBST is much higher as compared to other agents or components such as PLA (including variations thereof such as PLLA, PDLA and PLDLLA, for example).

Therefore, the use of PBS and/or PBAT and/or PBST in a food packaging element, preferably in and/or for a packaging unit from moulded pulp, significantly improves the sustainability of the packaging element and/or packaging unit. This improves recycling possibilities and biodegrading or decomposing the packaging element and/or packaging unit. For example, the use of PBS and/or PBAT and/or PBST may obviate the need for non compostable polyethylene (PE) as inner liner.

In a further preferred embodiment of the invention the (laminated) multi-layer comprises a colouring agent.

By providing a colouring agent the visual appearance of the packaging element and/or packaging unit provided with the packaging element of the invention can be improved.

Furthermore, this can be used to provide a consumer with additional information. For example, Indian meals or spicy food can be provided in a red coloured packaging element, brown or black for (chocolate) bars, fish in a blue coloured packaging element, and Italian food including ice cream can be provided in a green coloured packaging unit. It will be understood that these examples can be extended to other exchanges of information with a consumer.

Preferably, the colouring agent is biodegradable and more preferably compostable. This maintains the packaging unit as a whole being biodegradable or even compostable.

Optionally, in addition or as an alternative, a colouring agent is added to the moulded or fluff pulp of the packaging unit that is provided with the packaging element according to the invention, preferably as a soluble dye. These agents can be cationic or anionic and are in another classification also referred to as basic dyes, direct dyes or acid dyes. In a presently preferred embodiment cationic colouring agents are used. Optionally, the moulded or fluff pulp material can be coloured using additives, dyes (basic dyes, direct dyes, anionic and/or cationic charged dyes), pigments or other components that provide colour to the packaging unit. This enables providing the packaging unit with a colour representative for its (intended) contents.

In a further preferred embodiment of the invention the (laminated) multi-layer comprises a print. By providing a (laminated) multi-layer with a print the possibilities to provide a consumer with additional information or extended print.

The packaging element according to the invention is biodegradable as a whole. This is preferably also the case for a combination of packaging unit with packaging element according to the invention. More preferably, the packaging element, and preferably also the packaging unit, is biodegradable at a temperature in the range of 5 to 60° C., preferably in the range of 5 to 40° C., more preferably in the range of 10 to 30° C., even more preferably in the range of 15 to 25° C., and most preferably at a temperature of about 20° C. This renders decomposing of the packaging element, and preferably packaging unit, easier. Furthermore, this enables so-called ambient or at home decomposing of the packaging element, and preferably packaging unit, according to the invention. For example, the packaging element, and preferably packaging unit, according to the invention may be industrial and/or home compostable according to EN 13432.

Tests with a packaging unit that is provided with a packaging element in an embodiment of the invention showed a home compostability wherein the packaging unit decomposed within 24 weeks in accordance with the accepted practical standard.

Optionally, the biodegradable aliphatic polyester, such as PBS, can be manufactured from fossil resources. More preferably, the biodegradable aliphatic polyester, such as PBS, is bio-based and made from plant resources, for example. Such bio based biodegradable aliphatic polyester, such as PBS, further improves the sustainability of the food packaging element.

The present invention further relates to a food packaging unit comprising a biodegradable multi-layer packaging element according to one of the embodiments of the invention.

The food packaging unit provides the same or similar effects and advantages as described in relation to the packaging element.

The food packaging unit according to the invention preferably comprises a compartment capable of receiving or carrying or holding a food product. For example, a food receiving compartment may relate to a compartment capable of holding a food product, such as eggs, tomatoes, kiwis, or a container for holding a beverage, yoghurt, coffee milk. A carrying compartment may relate to a carrier surface whereon or wherein a food product can be placed, such as a plate, cup, bowl, bottle divider etc. In other embodiments according to the invention, the food receiving compartment is capable of receiving and holding a meal, for example ready meals, salads, meat etc.

The packaging element preferably provides a foil to cover the compartment(s) of the food packaging unit.

The packaging unit according to the invention is preferably compostable thereby providing a sustainable packaging unit. This provides a biodegradable alternative material to conventionally used plastics, for example. This improves recycling properties of the packaging units that are preferably made from moulded or fluff pulp (including so-called virgin fiber material and/or recycled fiber material) and comprise a biodegradable (laminated) multi-layer as a packaging element. In several of the presently preferred embodiments of the invention the packaging unit is also marine degradable, thereby further improving the sustainability of the packaging unit.

According to the invention the food packaging unit comprises a biodegradable (laminated) multi-layer of the packaging element. This (laminated) multi-layer is in some of the presently preferred embodiments of the invention provided on or at a food contact surface of the food receiving and/or carrying compartment. In some other embodiments of the invention the (laminated) multi-layer is provided in the moulded or fluff pulp material of the food receiving and/or carrying compartment.

According to the present invention the packaging unit with the food receiving and/or carrying compartment is manufactured from a moulded or fluff pulp material. In a presently preferred embodiment the (laminated) multi-layer of the packaging element is co-extruded with the moulded pulp material and thereafter deep-drawn into the desired shape of the packaging unit. In another presently preferred embodiment the (laminated) multi-layer is provided in an in-mould operation, preferably in combination with an in-mould drying operation. As a further alternative the (laminated) multi-layer is (laminated) on the moulded or fluff pulp material, optionally comprising one or more of: deep-drawing with underpressure/vacuum, heating, providing overpressure at the top side. The multi-layer according to the invention showed effective capabilities of being deep-drawn in the packaging unit. In alternative embodiments (raw) fluff pulp material is used that preferably comprises long fibre softwoods. After pre-treatment the fluff pulp material is provided for the air-laid flow. To provide the fluff pulp material to the mould a binder may be used, for example as a spray or foam. This reduces the amount of water that is used in the manufacturing process for a conventional moulded fiber (packaging) product. In fact, in conventional moulded pulp products water is used as a carrier. Obviating the need for water as a carrier significantly reduces the amount of water that is required in the manufacturing process. This results in a significant reduction of the energy that is required for drying the resulting products. Also, this significantly reduces the carbon footprint of the end-products that are manufactured according to the method of the present invention. By providing the fluff pulp material to a mould a 3-dimensional shaped product can be manufactured. To provide the (laminated) multi-layer to the fluff pulp one or more of the aforementioned or other process steps can be applied including co-extruding and laminating. The air-laid processing step preferably also includes so-called spun-laid processing. In a presently preferred embodiment of the invention the packaging element with barrier properties is provided to the 3-dimensional shaped mould. This renders it possible to manufacture the product from a fluff pulp material and the (laminated) multi-layer with a barrier material in one mould. This improves efficiency of the manufacturing process. Furthermore, providing the fluff pulp material and barrier material in the same mould and performing a heat and/or pressing/pressure treatment improves adherence of the materials. This provides additional strength and stability to the end-product.

In one of the presently preferred embodiments the (laminated) multi-layer with functional barrier layer is provided as an intermediate layer between two layers of fluff or moulded pulp material. In this embodiment the barrier layer is sort of encapsulated by the layers of fluff or moulded pulp material. Optionally, further layers are provided to further enhance the properties and characteristics of the end-product.

In a presently preferred embodiment of the invention the (laminated) multi-layer with functional barrier layer is provided on one side of the product, i.e. the food contact surface of the compartment. This may reduce the overall wall thickness of the end-product as compared to an embodiment with encapsulated barrier layer.

Preferably, the material of the packaging unit is sufficiently refined to further enhance the desired characteristics. Especially, applying a refining energy of about 150 kWh/ton material showed a good effect. As a further effect, an overall weight reduction of the packaging unit can be achieved of up to about 20% without affecting the strength and stability of the packaging unit as compared to conventional products, such as crystallisable polyethyleneterephthalate (CPET) or polypropylene (PP) trays or the like. Optionally, additional additives can be added to further improve the packaging unit properties. For example, an amount of alkyl ketene dimer (AKD) can be provided to improve the water repellence.

As a further advantage, the packing unit with the (laminated) multi-layer of the packaging element renders it possible to provide the packaging unit with a paper look and paper feel. This improves consumer perceptance of the packing unit. Optionally, one or more paper layers are included in the packaging element.

An even further advantage when applying a (laminated) multi-layer is the insulating effect that is provided to the food packaging unit. This is especially relevant in case of instant meals that are heated in a magnetron. For example, conventional packaging units heat up to a temperature of 90 to 100° C. with the similar packaging unit that is provided with a (laminated) multi-layer heating up to 50 to 70° C. This improves the safety of using such meals. Experiments showed that it was possible to achieve a temperature resistance of the packing units up to 200° C. and even up to 220° C. This improves the so-called “cool-to-touch” characteristic of the packaging unit. This prevents a consumer from being injured when removing a packaging unit from the oven. More specifically, “cool-to-touch” relates to an outside packaging temperature in the range of 10 to 30° C. after heating the product in an oven, for example. This is a lower temperature as compared to conventional CPET packaging units, for example. Therefore, the packaging unit according to the invention is more safe in use.

As an even further advantage, the packaging unit with the (laminated) multi-layer of the packaging element maintains the biodegradability and/or compostable properties of the packaging unit as it obviates the need for the use of fluorochemicals as is required in conventional packaging units, for example in the production of disposable tableware. The production of disposable tableware is for example the production of Chinet disposable tableware. Therefore, the packaging unit according to the present invention improves the sustainability of handling food products. In fact, this enables decomposing the food packaging unit as a whole. In such preferred embodiment, the food packaging unit can be decomposed at home, thereby rendering the food packaging unit home-compostable. Such home-compostable packaging unit further improves the overall sustainability of the packaging unit of the invention. This enables replacing the use of less sustainable materials, such as CPET, PP, PE, polystyrene (PS), aluminium in food packaging units.

A further advantage of providing a packaging unit with the multi-layer of the packaging element according to the present invention is the possibility to apply modified atmosphere conditions in the packaging unit. The barrier properties preferably act in both directions, from outside to the inside, and from the inside to the outside. This enables so-called MAP-products that may further improve shelf-life, for example.

In one of the presently preferred embodiments of the invention the (laminated) multi-layer of the packaging unit is melted or fused with a compartment of the packaging unit that receives and/or holds the food. Preferably, the (laminated) multi-layer is provided on a food contact surface of the compartment to improve shelf-life of the food.

In a presently preferred embodiment the packaging unit comprises a layer of biodegradable aliphatic polyester on a food contact surface to improve melting and/or fusing of the (laminated) multi-layer of the packaging element thereon. This provides a good connection between the compartment and the (laminated) multi-layer and also maintains the compostability properties of the packaging unit according to the invention. Actually, such optional layer of biodegradable material functions as binder for the connection between the (laminated) multi-layer and the packaging unit. This also improves the strength and stability of the (laminated) multi-layer and the packaging unit as a whole. The thickness of this thin layer is preferably in the range of 1 to 100 μm.

Alternatively, or in addition thereto, the (laminated) multi-layer of the packaging element is melted and protrudes into and/or is integrated in the moulded or fluff pulp material matrix. This provides the material matrix of the packaging unit with the desired properties.

By providing a heating step the melting and/or fusing of the (laminated) multi-layer to the biodegradable aliphatic polyester fibres in the moulded or fluff pulp material is further improved. In fact, the heating step improves the adherence/connection of the (laminated) multi-layer to the packaging unit. This heating step can be performed in a press that pushes the (laminated) multi-layer into the correct shape onto the food contact surface. Alternatively, in one of the presently preferred embodiments of the invention, the (laminated) multi-layer is provided inside the mould wherein the package unit is manufactured from the moulded pulp material. The (laminated) multi-layer is provided in the mould onto the packaging unit. The food packaging unit with the (laminated) multi-layer can be dried in the mould involving a so-called in-mould drying operation or can alternatively be dried in an additional separate drying step after releasing the product from the mould.

In addition, or as an alternative, spray coating can be applied to improve the water and/or fat repellence. Preferably, an emulsion is sprayed on the packaging unit that builds a thin film layer in the processing of the packaging unit.

Optionally, the (laminated) multi-layer of the packaging unit is provided applying pre-stress to the (laminated) multi-layer. In another embodiment, to reduce the risk of providing a (laminated) multi-layer with reduced thickness in the corners of the packaging unit, the (laminated) multi-layer is designed and shaped according to the desired dimensions and thereafter provided to the packaging unit. This may involve cutting the design of the (laminated) multi-layer and folding it onto the food contact surface. Thereafter, in one of the presently preferred embodiments, the heating step is performed to melt or fuse the materials together.

Many food packaging units are provided with a packaging element, more specifically a foil, such as a cover or seal or film, to cover the compartment with the food product(s). A problem with conventional food packaging units relates to such top seal film that needs to be disposed separately from the other part(s) of the packaging unit. This requires attention when disposing the packaging unit and/or increases the risk of mixed waste streams.

According to a preferred embodiment of the invention the packaging unit may comprise a biodegradable packaging element, more specifically a biodegradable top seal film, according to the invention. Providing such biodegradable top seal film provides a fully biodegradable and compostable packaging unit for food products. This enhances disposal possibilities for the material, thereby obviating the risk of mixed waste streams. Furthermore, it reduces the amount of residual waste. This significantly improves the sustainability of the food packaging industry.

Preferably, the packaging unit is provided with a circumferential edge comprising a connecting surface for the top seal film that is substantially free of the (laminated) multi-layer.

Such edge or alternative connecting surface enables the adherence of the top seal film to the compartments of the packaging unit. In some embodiments packaging units are provided with a (transparent) seal, foil, film, sheet or liner closing the opening of the packaging unit. In fact, this layer acts as a closure to the packaging unit. The use of a biodegradable aliphatic polyester such as PBS and/or PLA in packaging units contributes to the adherence of this closure to the packaging unit. In fact the biodegradable aliphatic polyester (partly) acts as an adhesive or glue.

It was shown that this contributes to the hot seal peelability, i.e. removing the transparent layer after the packaging unit is heated in a microwave for example, and/or to the cold seal peelability, i.e. removing the transparent layer when taking the packaging unit from the fridge and before heating for example.

Optionally, a thin layer of biodegradable aliphatic polyester is provided to adhere the transparent layer of the packaging element to the edge of the packaging unit. Preferably, the transparent layer is also home compostable. In a presently preferred embodiment the transparent layer comprises an amount or mixture of PBS, PHBT and/or PLA. Optionally, a thin anti-fog layer is provided to improve the transparency of the layer. Also optionally, the transparent layer comprises an amount of PVOH to improve the performance in relation to the O₂-permeability. This can advantageously be applied to packaging units for meat and meat products, for example.

In a presently preferred embodiment of the invention the top seal film according to a packaging element of the invention also comprises one or more biodegradable aliphatic polyesters. This may improve the adherence of the top seal film to the (laminated) multi-layer and/or to the moulded or fluff pulp material. Optionally, a separate adherence layer is provided.

In a presently preferred embodiment a print is provided on the pulp material oriented side of the (laminated) multi-layer in a mirror image such that the print can be seen from the (other) food side of the (laminated) multi-layer. This reduces the risk of the printing ink to come in contact with the food.

In a further preferred embodiment of the invention the amount of biodegradable aliphatic polyester in the food packaging unit is in the range of 0.5 to 20 wt. %, more preferably in the range of 1 to 15 wt. %.

By applying an amount of biodegradable aliphatic polyester in one of the aforementioned ranges, the sustainability and packaging characteristics of the (food) packaging elements and/or packaging units according to the present invention is significantly improved. The biodegradable aliphatic polyester is provided in the biodegradable (laminated) multi-layer and/or in the matrix of the moulded or fluff pulp material and/or as a separate layer on the compartment.

In a further preferred embodiment of the invention the amount of biodegradable aliphatic polyester is in the range of 2 to 10 wt. %, preferably in the range of 5 to 9 wt. %, and most preferably in the range of 6.5 to 8 wt. %.

Applying an amount of biodegradable aliphatic polyester in these ranges provides packaging elements and/or packaging units that are both stable and strong.

Another advantage when using a biodegradable aliphatic polyester in a (food) packaging element and/or packaging unit is the constancy of size or dimensional stability.

In a further embodiment of the present invention the packaging unit further comprises an amount of natural fibers and/or alternative fibers.

Providing an amount of natural fibers and/or alternative fibers provides a natural feel to the packaging unit and/or improves the overall strength and stability of the packaging unit. Such natural/alternative fibers may comprise fibers from different origin, specifically biomass fibers from plant origin. This biomass of plant origin may involve plants from the order of Poales including grass, sugar cane, bamboo and cereals including barley and rice. Other examples of biomass of plant origin are plants of the order Solanales including tomato plants of which the leaves and/or stems could be used, for example plants from the Order Arecales including palm oil plants of which leaves could be used, for example plants from the Order Maphighiales including flax, plants from the Order of Rosales including hemp and ramie, plants from the Order of Malvales including cotton, kenaf and jute. Alternatively, or in addition, biomass of plant origin involves so-called herbaceous plants including, besides grass type plants and some of the aforementioned plants, also jute, Musa including banana, Amarantha, hemp, cannabis etcetera. In addition or as an alternative, biomass material origination from peat and/or moss can be applied.

Preferably, the (lignocellulosic) biomass of plant origin comprises biomass originating from plants of the Family of Poaceae (to which is also referred to as Gramineae). This family includes grass type of plants including grass and barley, maize, rice, wheat, oats, rye, reed grass, bamboo, sugar cane (of which residue from the sugar processing can be used that is also referred to as bagasse), maize (corn), sorghum, rape seed, other cereals, etc. Especially the use of so-called nature grass provides good results when manufacturing packaging units such as egg packages. Such nature grass may originate from a natural landscape, for example. This family of plants has shown good manufacturing possibilities in combination with providing a sustainable product to the consumer.

In another preferred embodiment the biomass of plant origin comprises material from the coffee plant (Coffea) in the family Rubiaceae. Optionally, this biomass is used in combination with other biomass. The coffee plant biomass can advantageously be used for coffee related products, such as coffee capsules.

Preferably, in one of the embodiments of the invention the packaging unit comprises an amount of micro fibrillated cellulose (MFC) sometimes also referred to as nanofibrillar cellulose or cellulose nanofibers or nanocellulose. MFC preferably originates from cellulose raw material of plant origin. The use of MFC enhances the fiber-fiber bond strength and further improves the reinforcement effect. Although MFC is preferably applied in combination with one or more of the biodegradable aliphatic polyesters, it is also possible to use MFC as an alternative to these components.

In an embodiment of the invention the bio-polymers and/or MFC provide a biofilm on or at (a part of) the surface of the packaging unit. Experiments indicate that good barrier properties can be achieved. Alternatively, or in addition thereto, a paper look and/or paper feel surface layer can be provided. For example, a paper layer can be sealed onto a thin layer of (bio)film or a thin layer of biofilm or biopolymer can be coated or laminated onto the paper layer. The biopolymer layer can be sealed onto the surface of a tray or container for food, for example. This paper look and/or paper feel surface layer contributes to the consumer's appreciation of the packaging unit according to such embodiment of the invention. Tests have shown a good wet strength and barrier properties. Barrier properties may include oxygen and/or grease barriers. It is believed that the oxygen barrier properties are achieved by the ability of MFC to form a dense network involving hydrogen bonds.

Optionally, some hydrophobic elements are added to an MFC layer to further improve the water barrier properties. This may involve modification of the hydroxyl groups, for example on the surface of the micro fibrils chemically and/or by absorption of polymers, for example.

A further advantage of the use of MFC is the improved printability, including digital printing possibilities. In addition or as an alternative, MFC may reduce cost by reducing the weight or grammage by increasing the amount of fillers. This may also enhance the optical properties.

It will be understood that combinations of MFC and/or biodegradable aliphatic polyesters may further improve the mentioned effects and advantages. Also, combinations with conventional polymer films, for example by coating MFC and/or a biodegradable aliphatic polyester thereon, may provide a product with the advantages of both types of material.

The present invention further also relates to a method for manufacturing a biodegradable multi-layer packaging element, such as a foil or wrap, for a food product, the method comprising the step of providing a (laminated) multi-layer comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

Such method provides the same or similar effects and advantages as described in relation to the packaging element and/or food packaging unit.

In accordance with the invention in some embodiments the packaging element is applied to a packaging unit from a moulded fiber material. In such embodiment the (laminated) multi-layer can be provided before or after releasing the food packaging unit from the mould. In one of the presently preferred embodiments the (laminated) multi-layer of the packaging element is co-extruded with the moulded pulp material and thereafter deep-drawn into the desired shape of the packaging unit. In another presently preferred embodiment the layer is provided in an in-mould operation, preferably in combination with an in-mould drying operation. In another presently preferred embodiment the packaging element is provided with one or more paper layers and can be used as wrap for food products, for example.

In a further preferred embodiment the method comprises the additional step of subjecting the packaging element and/or packaging unit to a heating step heating the packaging element and/or packaging unit to a temperature about the melting temperature of the biodegradable aliphatic polyester to crosslink/interact the packaging unit with the (laminated) multi-layer of the packaging element to increase strength and improve barrier properties. Preferably, the heating step heats the temperature of the packaging unit to a heating temperature in the range of 145 to 195° C., preferably in the range of 165 to 190° C., and most preferably to a temperature of about 180° C.

In a further preferred embodiment of the invention the manufacturing comprises the step of refining at least a part of the fibers of the moulded or fluff pulp material. It was shown that a higher degree of refining results in more and/or stronger bonding between the fibers. This increases strength of the packaging unit and/or reduces its weight. Preferably, the refining of the moulded or fluff pulp material is performed together with the biodegradable aliphatic polyester. The refining step improves the mixing of the materials and fibrillates the fibers. Refining the fibers may reduce fiber length, fibrillates fibers thereby providing more specific surface of fiber branches that improves binding and H-bridge formation which leads to a stronger, stiffer product. In fact, this improves the number and strength of connections between the moulded or fluff pulp material and the biodegradable aliphatic polyester such that the overall strength and stability of the packaging unit is improved. This is even further improved when combining the refining step with the heat treatment step to activate the biodegradable aliphatic polyester.

In a preferred embodiment of the invention the packaging unit may be negatively charged, for example in or after the refining step. To enhance the adherence of the (laminated) multi-layer and/or top seal film an ionisation step can be performed to remove, or at least reduce, the negative charge.

By adding an amount of biodegradable aliphatic polyester to the moulded or fluff pulp material, a packaging unit can be manufactured from a blend comprising fibers and biodegradable aliphatic polyester, and/or a separate layer comprising biodegradable aliphatic polyester. Such separate or additional layer may improve the fusing or melting process.

The method according to the invention provides a packaging element and/or food packaging unit comprising such packaging element that is more sustainable than conventional packaging elements and/or packaging units. Optionally, other bio-materials can be used in combination with the main biodegradable aliphatic polyester(s), such as starch and other polyesters like PBS, PLA or similar biodegradable components. Such combinations or alternatives may provide similar effects and advantages as described in relation to the packaging element and/or packaging unit.

Preferably, in the moulding step of the food packaging unit, the biodegradable aliphatic polyester connects to the celluloid fibres of the moulded pulp material. This provides a food packaging unit with sufficient strength. In a presently preferred embodiment these connections are achieved by activation of the biodegradable aliphatic polyester. This may involve subjecting the packaging unit to about the melting temperature of the biodegradable aliphatic polyester, for example 145 to 175° C. More specifically, the biopolymers melt and crosslink/interact with the (laminated) multi-layer to increase strength and change properties like barrier properties.

In some of the presently preferred embodiments the method further comprises the step of providing a top seal film of the packaging element according to the invention, preferably a biodegradable and/or compostable top seal film.

In one of the presently preferred embodiments, the method further comprises the step of performing sterilisation and pasteurisation on the (filled) packaging units. Preferably, the step of performing sterilisation and pasteurisation on the (filled) packaging units comprises dry sterilisation and pasteurisation on the (filled) packaging units. Especially, in combination with the oxygen (O₂)-barrier properties of the (laminated) multi-layer (and top seal film) the shelf-life of the food product is significantly improved. In addition, the oxygen (O₂)-barrier prevents or at least reduces oxidation processes in the food and thereby contributes to the maintenance of food taste.

In the life cycle of the packaging unit, in the context of the present invention, the manufacturing process of the packaging element and/or food packaging unit preferably also comprises the step of biodegrading the packaging element and/or packaging unit. Therefore, in relation to the present invention, preferably also the biodegradation of the packaging element and/or packaging unit is considered part of the entire manufacturing process. The biodegradation constitutes a significant part of the life cycle in view of the sustainability.

Preferably, the biodegrading comprises decomposing the food packaging element and/or packaging unit.

Even more preferably, the decomposing is performed at a temperature in the range of 5 to 60° C., preferably in the range of 5 to 40° C., more preferably in the range of 10 to 30° C., even more preferably in the range of 15 to 25° C., and most preferably at a temperature of about 20° C., thereby relating to ambient decomposing.

In presently preferred embodiments the bio-polymers that are applied originate from so-called non-gmo (non-genetically modified organisms) biopolymers.

In some of the preferred embodiments the method further comprises the steps of refining fibers for the moulded or fluff pulp material and/or adding an amount of natural fibers and/or alternative fibers. This provides the same or similar effects and advantages as were described in relation to the packaging unit.

Further advantages, features and details of the invention are elucidated on the basis of preferred embodiments thereof, wherein reference is made to the accompanying drawings, in which:

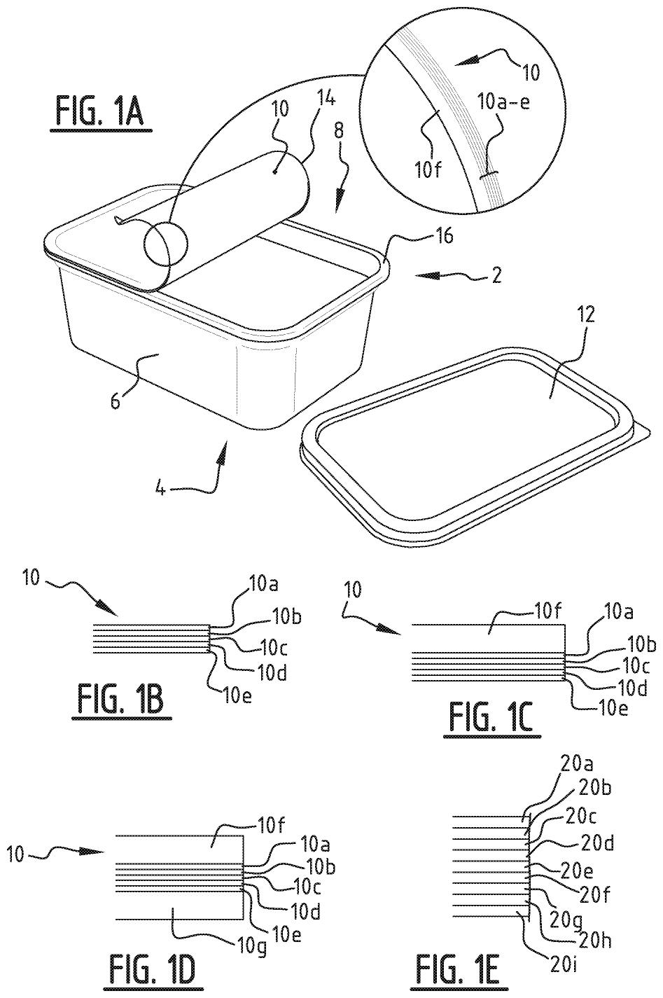

FIG. 1A shows a packaging unit for margarine having a packaging element according to the present invention as foil, more specifically acting as a cover;

FIG. 1B-E show different embodiments of a packaging element according to the invention

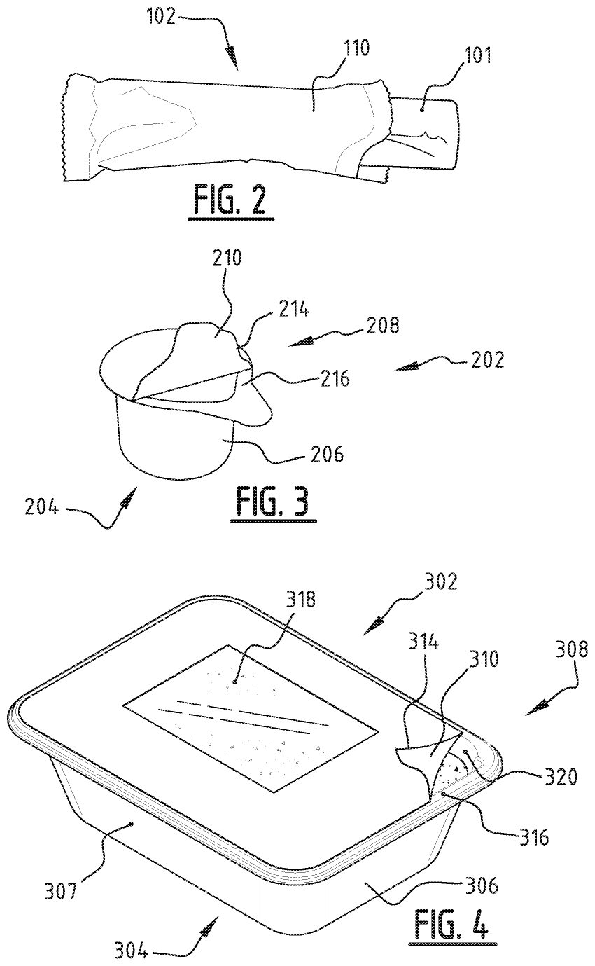

FIG. 2 shows a packaging element according to the invention as candy bar wrap;

FIG. 3 shows a container for coffee milk having a packaging element according to the invention as a foil;

FIG. 4 shows a food tray having a packaging element according to the invention as foil and having a paper layer with a window;

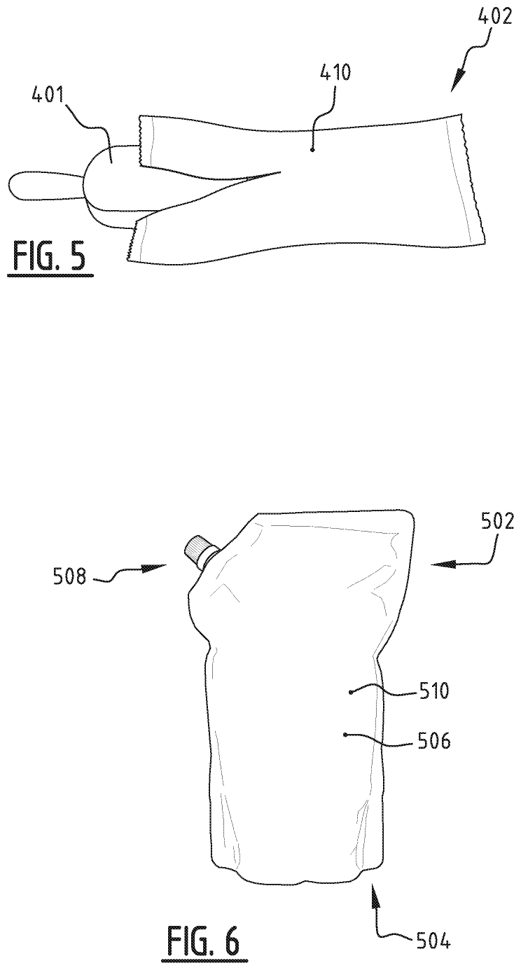

FIG. 5 shows a packaging element according to the invention as ice cream wrap;

FIG. 6 shows a pouch comprising a packaging element according to the invention;

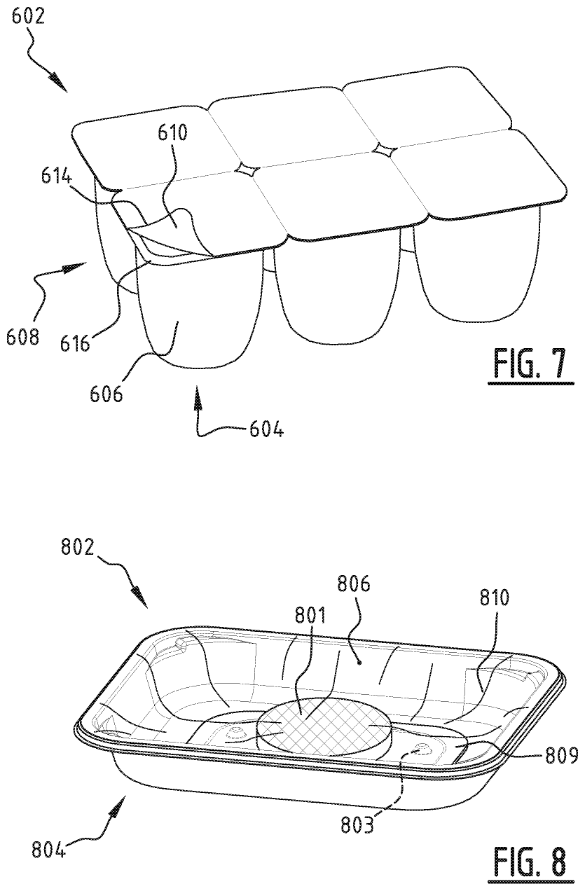

FIG. 7 shows a container for yoghurt having a packaging element according to the invention as foil;

FIG. 8 shows a meat container having a packaging element according to the invention as foil; and

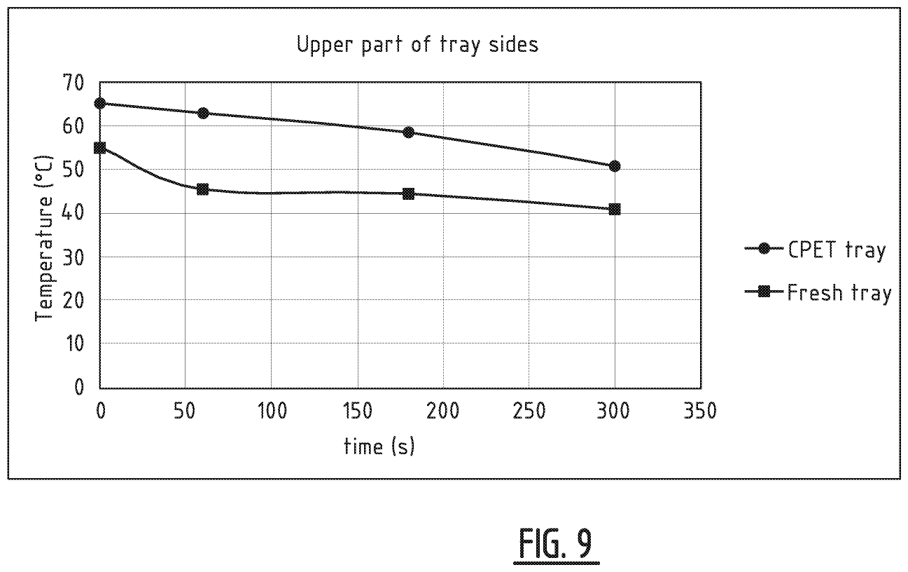

FIG. 9 shows experimental results with conventional packaging units and packaging units according to the present invention.

Container 2 (FIG. 1A) relates to a container for margarine. Container 2 has bottom part 4 and side walls 6 defining opening 8. Before use, opening 8 is covered with packaging element 10 comprising a biodegradable (laminated) multi-layer 10. In this embodiment there is provided a separate cover 12.

In the illustrated embodiment container 2 is provided with peelable packaging element 10. Edge 14 of packaging element 10 is peeled from edge 16 of container 2. In this embodiment packaging element 10 comprises a number of layers as transparent film and a paper layer. It will be understood that layers can also be provided as non-transparent, or alternatively as semi-transparent and/or partly transparent. Alternatively, container 2 can also be provided without cover 12.

Optionally, container 2 is manufactured from a moulded pulp material and comprises an additional film layer of biodegradable aliphatic polyester and/or may comprise an amount of biodegradable aliphatic polyester that is blended into the moulded pulp. This renders bottom part 4 and/or walls 6 water or liquid repellent and/or improves the heating step to melt or fuse (laminated) multi-layer 10 on or to edge 16. One of the further advantages of the use of biodegradable aliphatic polyester is the reduction or prevention of the liquid entering or migrating into the material during use. Another advantage is the constancy of size or dimensional stability.

Biodegradable packaging element 10 comprises a (laminated) multi-layer (FIG. 1B) comprising first cover layer 10a, first intermediate layer 10b, central functional layer 10c, second intermediate layer 10d, and second cover layer 10e. it will be understood that other layers can be added to multi-layer 10. It will be understood that (laminated) multi-layer 10 can be applied to container 2 and/or other packaging units that are illustrated or are not illustrated.

In an alternative embodiment (FIG. 1C) packaging element 10 comprises paper layer 10f. In a further alternative embodiment (FIG. 1D) packaging element 10 comprises second paper layer 10g. In this embodiment paper layers 10f, 10g provide a sandwich type configuration for multilayers 10a-e.

An alternative biodegradable packaging element 20 with a (laminated) multi-layer 20 (FIG. 1E) comprises first cover layer 20a, first intermediate layer 20b, first functional layer 20c, second intermediate layer 20d, central flexible layer 20e, third intermediate layer 20f, second functional layer 20g, fourth intermediate layer 20h, and second cover layer 20i. It will be understood that other layers can be added to multi-layer 20. It will be understood that (laminated) multi-layer 20 can be applied to container 2 and/or other packaging units that are illustrated or are not illustrated. It will also be understood that one or more paper layers 10f, 10g can be applied to multi-layer 20.

Wrap 102 (FIG. 2) comprises packaging element 110 for a candy bar 101 with a number of layers 10a-e, 20a-i and a paper layer 10f. Paper layer 10f is provided with text and illustrations.

Container 202 (FIG. 3) for holding coffee milk comprises bottom part 204 and side walls 206 defining opening 208. Before use, opening 208 is covered with packaging element 210 comprising a biodegradable (laminated) multi-layer 210, preferably according to one of the embodiments illustrated in FIGS. 1A-C.

In the illustrated embodiment container 202 is provided with peelable packaging element 210. Edge 214 of packaging element 210 is peeled from edge 216 of container 202. In this embodiment packaging element 210 comprises a number of layers 10a-e, 20a-i and a paper layer 10f.

Food tray 302 (FIG. 4) comprises bottom part 304 and side walls 306 defining compartment 307 configured for receiving and holding a product, and opening 308. Before use, opening 308 is covered with packaging element 310 comprising a biodegradable (laminated) multi-layer 310.

In the illustrated embodiment container 302 is provided with peelable packaging element 310. Edge 314 of packaging element 310 is peeled from edge 316 of container 302. In this embodiment packaging element 310 comprises a number of layers 10a-e, 20a-i as transparent film and a paper layer 10f. It will be understood that layers can also be provided as non-transparent, or alternatively as semi-transparent and/or partly transparent. In the illustrated embodiment paper layer 10f is provided with opening 318 enabling a consumer to inspect the contents of compartment 307.

Inner surface 320 of packaging unit 302 comprises PBS and/or PBAT and/or PBST and/or PLA material, optionally as film layer or alternatively blended and/or integrated with the fibres of the moulded pulp material. In the illustrated embodiment container 302 is manufactured from a moulded pulp or fluff pulp material, optionally comprising an amount of natural fibers and/or alternative fibers. This improves the possibilities for giving packaging unit 302 a natural paper feel and/or look. This may also be applied to other type of packaging units. For example, in instant or ready-to-eat meals, such that conventional sleeves can be omitted from the packaging units. This enables a more cost-efficient packaging unit with a possible weight reduction.

Packaging unit 302 has numerous applications, including but not limited to, airplane meals. Such meals are provided to the airplane after (dry) sterilisation and pasteurisation. In combination with the (O₂)-barrier properties of the (laminated) multi-layer (and top seal film) the shelf-life of the food product is significantly improved. In addition, the O₂-barrier prevents or at least reduces oxidation processes in the food and thereby contributes to the maintenance of food taste.

Wrap 402 (FIG. 5) comprises packaging element 410 for a candy bar 401 with a number of layers 10a-e, 20a-i and a paper layer 10f. Paper layer 10f is provided with text and illustrations.

Pouch 502 (FIG. 6) for holding solid and/or liquid products such as soup comprises bottom part 504 and side wall 506 with opening 508. In the illustrated embodiment bottom part 504 and side wall 506 comprises packaging element 510. In this embodiment packaging element 510 comprises a number of layers 10a-e, 20a-i and a paper layer 10f.

Container 602 (FIG. 7) for holding a food product such as yoghurt comprises bottom part 604 and side walls 606 defining opening 608. Before use, opening 608 is covered with packaging element 610 comprising a biodegradable (laminated) multi-layer 610.

In the illustrated embodiment container 602 is provided with peelable packaging element 610. Edge 614 of packaging element 610 is peeled from edge 616 of container 602. In this embodiment packaging element 610 comprises a number of layers as transparent film 10a-e, 20a-i and paper layer 10f. It will be understood that layers can also be provided as non-transparent, or alternatively as semi-transparent and/or partly transparent.

Packaging unit 802 (FIG. 8) for holding meat 801 comprises bottom part 804 and side walls 806 defining an opening. Bottom part 804 comprises a number of protrusions or spikes 803. In the illustrated embodiment meat 801 lies on foil 809 and is covered by packaging element 810 having a number of layers 10a-e, 20a-i that are preferably transparent. Lower foil 809 also comprises a number of layers 10a-e, 20a-i and/or comprises an absorbent material.

It will be understood that other types of food packaging units and/or packaging elements can also be envisaged in accordance with the present invention. Other examples of food packaging products may relate to cup carriers, cups, plates and other table ware etc.

When manufacturing a packaging element 10, 110, 210, 310, 410, 510 and/or food packaging unit 2, 102, 202, 302, 402, 502 preferably a moulded pulp material is prepared. Optionally, an amount of biodegradable aliphatic polyester, such as PBS and/or PBAT and/or PBST and/or PHBH, is blended or mixed into the moulded pulp material and/or an amount of biodegradable aliphatic polyester, such as PBS and/or PBAT and/or PBST and/or PHBH is included in a separate layer that is provided in or on the packaging unit 2, 102, 202, 302, 402, 502. Such separate layer may improve the contact with (laminated) multi-layer 10, 110, 210, 310, 410, 510, optionally comprising a vinyl alcohol polymer, such as HAVOH and/or BVOH. Preferably, (laminated) multi-layer is co-extruded with the moulded pulp material and deep-drawn. In addition, or as an alternative, the raw unit is moulded. Optionally, the raw unit is dried in the mould applying an in-mould drying process. In such alternative embodiment (laminated) multi-layer 10, 110, 210, 310, 410, 510 is provided in the mould and a heating step is performed. Optionally, an additional layer of biodegradable aliphatic polyester is provided to improve the contact between the packaging unit and the (laminated) multi-layer. Finally the product is released from the mould.

Several post-drawing or post-moulding operations may optionally be performed in relation to unit 2, 102, 202, 302, 402, 502 optionally including, but not limited to, labelling including in-mould labelling, marking including printing and digital printing, testing. In several of the preferred embodiments, the compostable (laminated) multi-layer 10, 110, 210, 310, 410, 510 is at least arranged on the food contact area of the product containing part of the packaging unit. In preferred embodiments this film is capable of being used in a microwave or oven as a so-called ovenable film. Preferably, layer 10, 110, 210, 310, 410, 510 is capable of withstanding temperatures up to 170° C., 190° C., or even higher. The biodegradable aliphatic polyester preferably comprises an amount of PBS and/or PBAT and/or PBST and/or MFC and/or biodegradable aliphatic polyester that may comprise an amount of one or more of PHB, PHA, PCL, PLA, PGA, PBAT, PBST, PHBH and PHBV. Especially a combination of a compostable packaging unit involving extrusion and/or in-mould drying further improves the sustainability as compared to conventional packaging units. The (digital) printable properties enable printing of packaging and/or food characteristics/information. This may obviate the use of separate sleeves, for example. In addition, it enables the application of prints, for example a fish & chips (newspaper) print on the packaging unit.

Experiments have been performed with one or more of the illustrated food packaging elements and/or units that were provided with (laminated) multi-layer 10, 110, 210, 310, 410, 510. These experiments involved comparing the “in-use” characteristics of the food packaging elements and/or units as compared to conventional packaging elements and/or units, and also the compostable characteristics. An amount of a biodegradable aliphatic polyester was added to the moulded pulp material and a refining step was performed. Measurements were done at a temperature of about 23° C. and a relative humidity of about 50%. Measurements involved a compression test. This showed a significant improvement in compression value. For example, a packaging unit with 7.5% PLA and a refining step showed a compression value of 450 to 500 N, while for a similar conventional product under the same conditions this value is about 180 N. Even a sub-optimal conditions of RH about 90% the compression value for the packaging unit according to the invention was about 250 to 270 N, thereby still outperforming the conventional product at its optimal conditions.

In a further test the multi-layer was applied to the food packaging element and/or unit and for 24 hours exposed to 23° C. and a relative humidity of about 50%. No oxygen penetration, referred to as the oxygen transfer rate (OTR), was detected. In fact, oxygen penetration was below 0.08 ml/m² day.

Further experiments in relation to the OTR were performed on several samples at a temperature of about 23° C. and a relative humidity of about 50%. Different multi-layers were tested. Samples in accordance with multi-layer 10 having one functional layer were tested having PBAT-PLA or PBAT cover layers and a GPolymer functional layer (thickness of 4 or 6 μm) and a total thickness of about 100 μm or about 120 μm, respectively. Also, samples in accordance with multi-layer 20 having two functional layers were testes having PBAT-PLA cover layers and two GPolymer functional layers (thickness of 2×2 or 2×3 or 2×4 μm) and a total thickness of about 80 μm, about 100 μm, about 120 μm, or about 150 μm, respectively, and a (central) flexibility layer of a blend of biopolymers, such as PBS, PBAT and/or PBST. Also, these samples showed an OTR below 0.08 ml/m² day, and even below 0.05 ml/m² day, which was the lowest test limit in this experiment. These experiments confirmed an OTR below 1 ml/m² d, and even below 0.1 ml/m² d, is achieved. Optionally, the inner and outer cover layers are provided with different thicknesses.

Further tests related to the water vapor transmission rate (WVTR). Several biofilms with multi-layer 10, 20 were tested. In Table 1 some experimental results are included. Tests were performed at a temperature of about 23° C. and a relative humidity of about 50%. In the table results are shown for two samples of the same composition.

TABLE 1
WVTR measurements

| | | measurement |
|---|---|---|
| Biofilm | measurement | type |
| PBS cover and | below 3000 mg/m² d | Aquatran |
| GPolymer (thick) | | |
| PBS cover and | below 3000 mg/m² d | Aquatran |
| GPolymer (thick) | | |
| PBS cover and | 3000-3500 mg/m² d | Aquatran |
| GPolymer (thin) | | |
| PBS cover and | 3000-3500 mg/m² d | Aquatran |
| GPolymer (thin) | | |
| PBAT-PLA cover | 2000-2500 mg/m² d | Aquatran |
| and GPolymer | | |
| PBAT-PLA cover | 2000-2500 mg/m² d | Aquatran |
| and GPolymer | | |
| Cover only: Blend | around 20 g/m² d | Permatran |
| PBAT and PLA | (indicative value)* | |
| Cover only Blend | around 20 g/m² d | Permatran |
| PBAT and PLA | (indicative value)* | |

Results show that water vapor transmission can be reduced significantly as compared to conventional materials that show water vapor transmission rates of up to 200 g/m² d. Also, at higher temperatures and pressures the transmission rate remains functional. Due to the fact that the functional layer of the biofilm is protected on both sides by a thin intermediate (tie) layer of PBAT (biopolyester) these layers avoid that the functional layer of GPolymer gets affected by water. This supports the good WVTR barrier properties of the entire film composition. Furthermore, the low water vapor transmission rate that is achieved also reduces the loss of aroma due to a high WVTR.

Other tests were performed to show the dual ovenable (oven and microwave) performance of the packaging element and/or unit according to the invention. In the experiments the (laminated) product was heated to a temperature of about 190° C. for about 30 minutes. Results show that the film layer remains intact and does not melt. No leakage was detected. Furthermore, the strength and stability of the packaging element and/or unit were not significantly affected. As a further effect, the packaging unit was more stable in view of twisting when removing the packaging unit from the oven as is often the case with conventional packaging units. Furthermore, the packaging element and/or unit of the invention showed a limited temperature increase to about 50 to 70° C., while the conventional units reached a temperature of about 90 to 100° C. under similar conditions. Other experiments with a (food) tray shows an even improved heat resistance when heating the tray to a temperature of 180 to 200° C., and in addition shows (an improved) oil, acid and moisture resistance/repellence.

Other test were performed to show the performance of the packaging unit according to the invention by heating the packaging unit in an oven and/or microwave. In the experiments the (laminated) product, comprising a (laminated) layer with a total thickness of about 40 μm, was heated to a temperature of about 180° C. for about 35 minutes. Results show that the film layer remains intact and does not melt. No leakage was detected. Furthermore, the strength and stability of the packaging unit were not significantly affected. As a further effect, the packaging unit was more stable in view of twisting when removing the packaging unit from the oven as is often the case with conventional packaging units. Leaking of the film layer was tested by using food simulantia such as 95% ethanol, modified polyphenylene oxide (MPPO), 2,2,4-trimethylpentane, and the like. Thus, this test showed a safe use of the laminate product as packaging, for example food packaging.

Additional tests compared the temperature on the outside of the packaging element and/or unit after cooking (“cool to touch”) with different types of meals by heating in both the microwave and oven between a conventional packaging unit from CPET (Crystalline Polyethylene Terephthalate) and a packaging unit that is about 100% biodegradable and made from moulded fibre. The cooking instructions for the ready meals were:
Microwave: 5 minutes at 700 Watt;
Oven: 30 minutes at 180° C. (air heated).

For the measurements, an IR (infrared) thermometer was used to observe the temperature on the outside of different parts of each tray/packaging unit.

Temperature of the food trays was measured regularly, starting directly after being taken out of the oven/microwave. Results for temperatures at the upper part of the trays are shown in FIG. 9 and are representative for the entire packaging units.

Results clearly show a substantial temperature difference in the range of 10-15° C. showing that the packaging unit according to the invention is cooler when being touched by a user. Food temperatures are similar in both packaging units during the entire time period. During the experiments it was observed that the CPET trays became “wobbly”/unstable after heating. In addition, the biodegradable packaging unit has a weight that is about 10% lower as compared to the CPET tray, while outperforming this CPET tray.

In still further tests other characteristics were examined. It was shown that wipeability of the packaging unit could be improved. Further improvements where shown by addition of further additives.

Also, shelf-life tests were performed. In these tests a packaging unit with a packaging element involving a (laminated) multi-layer as a top seal film according to the invention is compared to a conventional packaging unit for fresh meals. Tests revealed a significant shelf-life increase from about 8 days to 12 days.

The present invention is by no means limited to the above described preferred embodiments thereof. The rights sought are defined by the following claims, within the scope of which many modifications can be envisaged.

1. A biodegradable multi-layer packaging element, such as a foil or wrap, for a food product, with the multi-layer comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

2. The biodegradable multi-layer packaging element according to claim 1, wherein the multi-layer is a co-extruded laminated multi-layer.

3. The biodegradable multi-layer packaging element according to claim 1, further comprising a paper layer.

4. The biodegradable multi-layer packaging element according to claim 3, further comprising a second paper layer.

5. The biodegradable multi-layer packaging element according to claim 3, wherein the paper layer comprises an opening for a window.

6. The biodegradable multi-layer packaging element according to claim 1, wherein the thickness of the individual layers is within the range of 1.5 to 50 μm.

7. The biodegradable packaging unit according to claim 1, wherein the functional layer is positioned asymmetrically in the multi-layer.

8. The biodegradable multi-layer packaging element according to claim 1, wherein the biodegradable aliphatic polyester comprises an amount of one or more of PBS, PHB, PHA, PCL, PLA, PGA, PBST, PBAT, PHBH and PHBV.

9. (canceled)

10. The biodegradable multi-layer packaging element according to claim 1, wherein the multi-layer comprises a colouring agent that is biodegradable.

11. (canceled)

12. The biodegradable multi-layer packaging element according to claim 1, wherein the biodegradable aliphatic polyester is bio-based.

13. A food packaging unit comprising a biodegradable multi-layer packaging element according to claim 1.

14. The food packaging unit according to claim 13, wherein the biodegradable multi-layer packaging element forms a foil to cover a compartment of the food packaging unit,
wherein the biodegradable multi-layer is melted or fused with the compartment.

15. (canceled)

16. The food packaging unit according to claim 14, wherein the packaging unit comprises a layer of biodegradable aliphatic polyester on a contact surface to improve melting or fusing of the multi-layer thereon.

17. The food packaging unit according to claim 13, wherein the amount of biodegradable aliphatic polyester in the food packaging unit is in the range of 0.5 to 20 wt. %.

18. (canceled)

19. The food packaging unit according to claim 13, further comprising an amount of natural fibers and/or alternative fibers.

20. A method for manufacturing a biodegradable multi-layer packaging element, such as a foil or wrap, for a food product, the method comprising the step of providing a multi-layer comprising:
an inner cover layer comprising an amount of a biodegradable aliphatic polyester;
a first intermediate layer of a biodegradable material for connecting and/or sealing adjacent layers;
a functional layer comprising a vinyl alcohol polymer;
a second intermediate layer of a biodegradable material for connecting and/or sealing adjacent layers; and
an outer cover layer comprising an amount of a biodegradable aliphatic polyester.

21. The method according to claim 20, wherein providing the biodegradable multi-layer comprises the step of co-extruding the layers, and/or
further comprising the step of providing a food packaging unit and providing the biodegradable multi-layer to the food packaging unit, and/or
wherein the biodegradable multi-layer is melted or fused with at least a compartment of the food packaging unit, and/or
further comprising the step of providing the biodegradable multi-layer as a biodegradable top seal film.

22.-24. (canceled)

25. The method according to claim 20, further comprising the step of performing sterilisation and pasteurisation of the packaging units.

26. The method according to claim 20, further comprising the step of biodegrading or decomposing the packaging unit.

27. (canceled)

28. The method according claim 20, further comprising the step of adding an amount of natural fibers and/or alternative fibers.
